(19) United States
(12) Patent Application Publication
(10) Pub. No.: US 2026/0111234 A1
(43) Pub. Date: Apr. 23, 2026

(54) Processing Vector Instructions

(71) Applicant: Imagination Technologies Limited, Kings Langley (GB)

(72) Inventor: Peter Vrabel, Hertfordshire (GB)

(21) Appl. No.: 19/324,360

(22) Filed: Sep. 10, 2025

(30) Foreign Application Priority Data
Sep. 10, 2024 (GB) 2413286.2

(51) Int. Cl. G06F 9/38; G06F 9/30

(52) U.S. Cl. CPC G06F 9/3865; G06F 9/30036

(57) ABSTRACT

When an instruction is received, the instruction checks against older “in-flight” instructions for hazards, and stores a hazard flag in a control storage entry. An instruction will not start executing while the hazard flag is set. When the older instruction executes and produces a result to a register, it clears the hazard for the current instruction. The current instruction can start executing when no hazards remain.

### CROSS-REFERENCE TO RELATED APPLICATIONS AND CLAIM OF PRIORITY

This application claims foreign priority under 35 U.S. C. 119 from United Kingdom Patent Application No. GB2413286.2 filed on 10 Sep. 2024, the contents of which are incorporated by reference herein in their entirety.

### TECHNICAL FIELD

The present disclosure relates to the processing of instructions by a vector processing unit.

### BACKGROUND

A vector processing unit (VPU) is responsible for executing vector instructions and scalar floating-point instructions, which may include cryptographic instructions. The VPU receives decoded instructions from a control unit (e.g. a main pipeline control (MPC) of a central processing unit (CPU)) and then executes the instructions. Execution is primarily performed by reading the vector or floating point register files, sending the data through a vector data path, and then writing the result back to the vector or floating point register file.

If an instruction consumes (i.e. reads) data from a register that another vector instruction is in the process of producing (i.e. writing) to, the consuming instruction needs to wait until the result of the producing instruction is available. For instance, if a first instruction writes to register v0and a later instruction reads from register v0, the later instruction should not execute until the first instruction has finished executing.

The same problem occurs with vector instructions. A vector instruction is however even more complicated as it can read and write to multiple registers. E.g. a single instruction may read from registers v0 and v2, and write the sum of the data to register v4. The same instruction may also read from registers v1 and v3, and write the sum of the data to register v5.

### SUMMARY

This Summary is provided merely to illustrate some of the concepts disclosed herein and possible implementations thereof. Not everything recited in the Summary section is necessarily intended to be limiting on the scope of the disclosure. Rather, the scope of the present disclosure is limited only by the claims.

Previously, an instruction would either wait until all previous instructions have finishing executing and updating the necessary registers (which adds latency), or an instruction would need to detect if any of the older instructions are writing to a register that the instruction needs, and also detect if those older instructions have produced their result. One previous technique involves cracking an instruction into micro-ops, where each micro-op either writes to one register or reads from one register, and the micro-ops determine hazarding information. When an instruction starts executing, the instruction looks at all in-flight instructions to check whether any are producing to a register that will be consumed by the executed instruction. If yes, the instruction works out where the data is, and then fetches the data from that location. This costs time and power.

The present invention uses control storage for tracking hazarding information associated with instructions that are to consume (i.e. read) from one or more registers. The storage is a structure that has one entry for each instruction that has not yet fully dispatched, and contains state needed to control the dispatch of instructions. Each entry may also contain the decoded instruction control for the associated instruction.

The hazarding information is used to control the processing of instructions. The hazarding information determines whether the instruction (e.g. individual micro-ops of the instruction) can consume from the relevant registers. In other words, the hazarding information tracks whether there are instructions that are in the process of producing to the relevant registers, and tracks each other instruction that the instruction is hazarding against. The hazarding information is pre-calculated before an instruction begins executing. That is, the hazarding information is determined at the point the instruction is received by the vector processing unit (e.g. the control storage of the vector processing unit).

When an instruction is received, the instruction (e.g. micro-ops of the instruction) checks against (e.g. all) older “in-flight” instructions for hazards. Here, a “hazard” occurs if an older instruction is to write to a register that is to be read by (a micro-op of) the new instruction. If an instruction has a hazard, the hazard information is stored in an entry of the control storage (e.g. along with other state tracking logic for the current instruction). The hazarding information includes which instruction or instructions the received instruction is hazarding against. An instruction will not start executing while the hazard information indicates that there is a hazard. When the older instruction executes and produces a result to a register, it clears the hazard for the current instruction, and the current instruction can start executing when no hazards remain.

According to one aspect disclosed herein, there is provided a computer-implemented method of processing instructions by a vector processing unit. The vector processing unit comprises control storage comprising a plurality of entries. The method comprises receiving a current instruction, wherein the current instruction is configured to consume from a set of target registers. The method further comprises determining that there is at least one respective earlier instruction that is configured to produce to one or more of the target registers. The method further comprises setting, in a respective entry of the control storage, a hazard indication indicating that there is respective earlier instruction configured to produce to one or more of the target registers. The current instruction may be prevented from consuming from the set of target registers whilst the respective entry comprises the hazard indication.

In embodiments, the method may comprise removing the hazard indication from the respective entry of the control storage when the respective earlier instruction produces to said one or more of the target registers. The method may further comprise processing the current instruction, which includes consuming from at least a first one of the target registers.

In embodiments, processing the current instruction may comprise, before consuming from at least the first one of the target registers, determining there are no respective earlier instructions configured to produce to at least the first one of the target registers, and only then consuming from at least the first one of the target registers.

In embodiments, processing the current instruction may comprise determining that there is at least one respective earlier instruction that is configured to produce to one or more of the target registers. Processing the current instruction may further comprise setting, in the respective entry of the control storage, a hazard indication indicating the at least one respective earlier instruction is configured to produce to one or more of the target registers. The current instruction may be prevented from consuming from the set of target registers whilst the respective entry comprises the hazard indication.

In embodiments, the method may comprise removing the hazard indication from the respective entry of the control storage when the respective earlier instruction produces to said one or more of the target registers. The method may further comprise processing the current instruction, which includes consuming from at least a second one of the target registers.

In embodiments, the current instruction may be configured to determine that there is at least one respective earlier instruction that is configured to produce to the one or more of the target registers.

In embodiments, the current instruction may be configured to set the hazard indication in the respective entry of the control storage.

In embodiments, the respective earlier instruction may be configured to remove the hazard indication from the respective entry of the control storage.

In embodiments, the current instruction may comprise a series of respective consume micro-ops, wherein each respective consume micro-op is configured to consume from a respective sub-set of the target registers. A respective first produce micro-op of a respective earlier instruction may be configured to produce to a respective sub-set of the target registers of a first respective consume micro-op. A respective second produce micro-op of a respective earlier instruction may be configured to produce to a respective sub-set of the target registers of a second respective consume micro-op. The method may comprise the respective first produce micro-op removing the hazard indication from the respective entry of the control storage upon producing to the respective sub-set of target registers of the first respective consume micro-op. The method may further comprise the respective first consume micro-op setting, in the respective entry of the control storage, the hazard indication indicating that there is a respective earlier instruction configured to produce to one or more of the target registers. The method may further comprise the respective second produce micro-op removing the hazard indication from the respective entry of the control storage upon producing to the respective sub-set of target registers of the second respective consume micro-op.

In embodiments, the method may comprise, for each respective earlier instruction, storing, in a respective entry of the control storage, a respective indication of each respective register that the respective earlier instruction will produce to. Determining that there is at least one respective earlier instruction that is configured to produce to one or more of the target registers may be based on the respective indications stored in the respective entries of the control cache.

According to another aspect disclosed herein, there is provided a vector processing unit comprising a plurality of registers configured to store data, and control storage comprising a plurality of entries. Each entry is configured to store state and/or logic associated with a respective instruction. The vector processing unit is configured to receive a current instruction, wherein the current instruction is configured to consume from a set of target registers of the plurality of registers, and determine that there is at least one respective earlier instruction that is configured to produce to one or more of the target registers. The vector processing unit is further configured to set, in a respective entry of the control storage, hazarding information indicating the at least one respective earlier instruction is configured to produce to one or more of the target registers; and to prevent the current instruction from consuming from the set of target registers whilst the respective entry comprises the hazard indication.

In embodiments, the vector processing unit may be configured to remove the hazard indication from the respective entry of the control storage when the respective earlier instruction produces to said one or more of the target registers. The vector processing unit may be further configured to process the current instruction, wherein processing the current instruction comprises consuming from at least a first one of the target registers.

In embodiments, the vector processing unit may be configured to determine there are no respective earlier instructions configured to produce to at least the first one of the target registers; and only consume from at least the first one of the target registers when there are no respective earlier instructions configured to produce to at least the first one of the target registers.

In embodiments, the vector processing unit may be configured to determine that there is at least one respective earlier instruction that is configured to produce to one or more of the target registers. The vector processing unit may be further configured to set, in the respective entry of the control storage, hazarding information indicating the at least one respective earlier instruction is configured to produce to one or more of the target registers, and to prevent the current instruction from consuming from the set of target registers whilst the respective entry comprises the hazard indication.

In embodiments, the vector processing unit may be configured to remove the hazard indication from the respective entry of the control storage when the respective earlier instruction produces to said one or more of the target registers, and to process the current instruction, wherein processing the current instruction comprises consuming from at least a second one of the target registers.

In embodiments, the current instruction may be configured to determine that there the at least one respective earlier instruction that is configured to produce to the one or more of the target registers. The vector processing unit may be configured to process the current instruction to determine that there is at least one respective earlier instruction that is configured to produce to one or more of the target registers.

In embodiments, the current instruction may be configured to set the hazard indication in the respective entry of the control storage. The vector processing unit may be configured to process the current instruction to set the hazard indication in the respective entry of the control storage.

In embodiments, the respective earlier instruction may be configured to remove the hazard indication from the respective entry of the control storage. The vector processing unit may be configured to process the respective earlier instruction to remove the hazard indication from the respective entry of the control storage.

In embodiments, the current instruction may comprises a series of respective consume micro-ops, each respective consume micro-op being configured to consume from a respective sub-set of the target registers. A respective first produce micro-op of a respective earlier instruction may be configured to produce to a respective sub-set of the target registers of a first respective consume micro-op. A respective second produce micro-op of a respective earlier instruction may be configured to produce to a respective sub-set of the target registers of a second respective consume micro-op. The vector processing unit may be configured to process the respective first produce micro-op to i) produce to the respective sub-set of target registers of the respective first consume micro-op, and ii) remove the hazard indication from the respective entry of the control storage. The vector processing unit may also be configured to process the respective first consume micro-op to set, in the respective entry of the control storage, the hazard indication indicating that there is a respective earlier instruction configured to produce to one or more of the target registers. The vector processing unit may also be configured to process the respective second produce micro-op to i) produce to the respective sub-set of target registers of the second respective consume micro-op, and ii) remove the hazard indication from the respective entry of the control storage.

In embodiments, the vector processing unit may be configured to for each respective earlier instruction, store, in a respective entry of the control storage, a respective indication of each respective register that the respective earlier instruction will produce to. The vector processing unit may also be configured to use the respective indications stored in the respective entries of the control storage to determine that there is the at least one respective earlier instruction that is configured to produce to one or more of the target registers. The hazarding information is ‘calculated’ when instructions arrive at the vector processing unit, and when non-final micro-ops start executing. Hazarding is ‘checked’ when the instruction starts executing. Hazarding is ‘modified’ when previous instructions execute. ‘Checking’ and ‘modifying’ the hazarding are much cheaper (in terms of area, power and timing) than ‘calculating’ the hazarding. Calculating the hazarding is costly because each instruction must be compared against every other instruction and every other micro-op.

Overall the invention requires fewer checks than the previous approach and is faster, less complicated, and less power hungry-an instruction only has to check whether it has any hazard flags set.

The processing system may be embodied in hardware on an integrated circuit. There may be provided a method of manufacturing, at an integrated circuit manufacturing system, a processing system. There may be provided an integrated circuit definition dataset that, when processed in an integrated circuit manufacturing system, configures the system to manufacture a processing system. There may be provided a non-transitory computer readable storage medium having stored thereon a computer readable description of a processing system that, when processed in an integrated circuit manufacturing system, causes the integrated circuit manufacturing system to manufacture an integrated circuit embodying a processing system.

There may be provided an integrated circuit manufacturing system comprising: a non-transitory computer readable storage medium having stored thereon a computer readable description of the processing system; a layout processing system configured to process the computer readable description so as to generate a circuit layout description of an integrated circuit embodying the processing system; and an integrated circuit generation system configured to manufacture the processing system according to the circuit layout description. The layout processing system may be configured to determine positional information for logical components of a circuit derived from the integrated circuit description so as to generate the circuit layout description of the integrated circuit embodying the graphics processing system.

There may be provided computer program code for performing any of the methods described herein. There may be provided non-transitory computer readable storage medium having stored thereon computer readable instructions that, when executed at a computer system, cause the computer system to perform any of the methods described herein.

The above features may be combined as appropriate, as would be apparent to a skilled person, and may be combined with any of the aspects of the examples described herein.

### BRIEF DESCRIPTION OF THE DRAWINGS

Examples will now be described in detail with reference to the accompanying drawings in which:

FIG. 1 shows an example processing system for processing instructions by a vector processing unit;

FIG. 2 shows a computer system in which a processing system is implemented; and

FIG. 3 shows an integrated circuit manufacturing system for generating an integrated circuit embodying a processing system.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is presented by way of example to enable a person skilled in the art to make and use the invention. The present invention is not limited to the embodiments described herein and various modifications to the disclosed embodiments will be apparent to those skilled in the art.

Embodiments will now be described by way of example only.

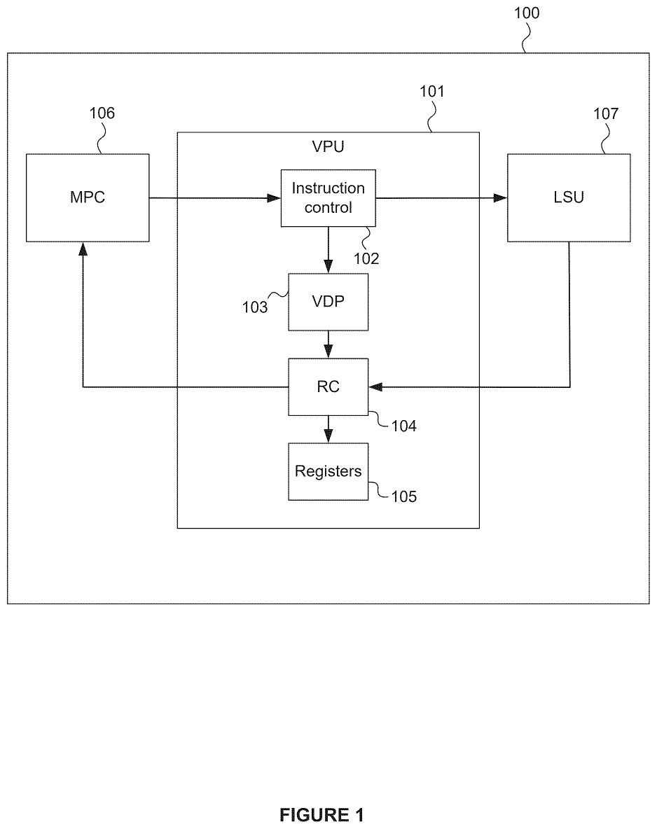

FIG. 1 illustrates an example processing system 100 for processing vector processing unit (VPU) instructions. Herein, a VPU instruction refers to any instruction processed (i.e. executed) by a VPU 101. For example, the instruction may be a vector instruction, a scalar floating-point instruction, a vector cryptographic instruction, or a matrix instruction.

The processing system 100 may be or gorm part of a RISC (e.g. RISC-V) Processing system.

The VPU 101 typically includes instruction control storage 102 which contains control and tracking logic for VPU instructions. The control storage 102 may include control and tracking logic for individual micro-ops of an instruction. For example, as shown in FIG. 1, a VPU 101 may include an operation cache (OC) 102 for tracking micro-ops. As another example, the VPU 101 may have a normal pipeline configured to handle vector instructions. Either way, the VPU 101 has storage for not-yet-dispatched instructions. The control storage 102 contains a plurality of entries. The operation of the control storage 102 will be described further below.

The VPU 101 will also typically include a vector data path (VDP) 103 configured to calculate the result of data-processing VPU instructions, and a results cache (RC) 104 configured to store data for VPU instructions which have executed but not yet written back to memory (e.g. one or more registers 105). The VPU 101 may comprise additional components.

The VPU 101 is configured to accept (i.e. receive) decoded VPU instruction control from a CPU, e.g. a main pipeline control (MPC) 106 of the CPU. The MPC 106 is also commonly referred to as a data processing unit (DPU). Any reference to MPC below may be replaced with “control unit”or DPU, unless the context requires otherwise.

The processing system 100 comprises an interface between the VPU 101 and the MPC 106, the interface being configured to pass VPU instructions and data between the VPU 101 and the MPC 106. The VPU 101 is configured to receive decoded instructions from the MPC 106, and then executes the instructions. Execution is primarily performed by reading the vector or floating point register files, sending the data through the VDP 103, then writing the result back to the vector or floating point register file.

The processing system 100 also contains one or more interfaces between the VPU 101 and LSUs 107, the LSUs 107 being configured to perform vector loads and stores and floating point loads and stores.

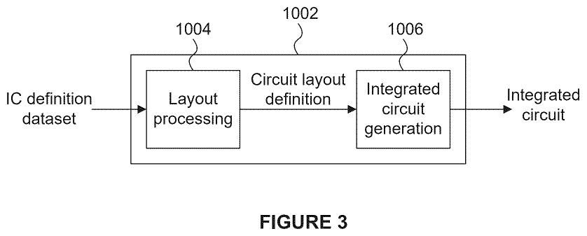

The VPU 101, MPC 107 and LSU 108 are all components of a central processing unit (CPU), e.g. CPU 902 shown in FIG. 3.

The VPU 101 may, in some situations, run ahead of the MPC 106, meaning that some instructions may have finished executing, and have the result available, before the instruction has been architecturally committed. In this case, the result is written to the result cache 104 and then sent from the result cache 104 into the appropriate register file 105 once the instruction is committed.

The following definitions are used throughout the present disclosure. “Issue” refers to when an instruction is sent from the MPC 107 to the VPU 101. “Commit” refers to when an instruction or micro-op becomes guaranteed to update architectural state. It cannot do any such update until it's committed. “Execute” refers to when a micro-op produces a result (e.g. a result that can be written to the architectural state once the instruction is committed). “Writeback” refers to when the micro-op or instruction has finished updating architectural state (e.g. register 106) with a result.

VPU instructions are sent from the MPC 106 to the VPU 101 in order. Instructions may be executed and perform architectural updates out of order, both with respect to other MPC instructions, and also with respect to other VPU instructions.

Turning now to the processing of vector instructions (i.e. instructions processed by the VPU 101). When an instruction is received at the VPU 101, state and/or control logic associated with the instruction is placed in a entry of the control storage 102. If the received instruction is a ‘consuming instruction’, i.e. an instruction that will consume (i.e. read) data from one or more target registers, the received instruction checks whether there are any earlier instructions that are configured to produce (i.e. write) data to any of those registers, but has not yet written the result to the register(s). In other words, the received instruction checks for in-flight instructions that will, eventually, write to any of the registers that are to be read by the received instruction.

The received instruction may be split (either by the MPC 107 or the VPU 101) into a series of micro-ops, one or more of which will consume from one or more registers. The checking for in-flight instructions may be performed by a first one of the micro-ops.

Each register required by the received instruction may be located in the same section of memory (e.g. register file 105), or in different sections of memory.

If an in-flight instruction is identified that will produce to one or more of the registers needed by the received instruction, a hazard indication (e.g. a flag) is set (i.e. entered) in the entry of the control storage 102 associated with the received instruction. Note that the hazarding indication (e.g. flag) is set for the whole instruction, not per micro-op. The VPU 101 is configured to prevent the received instruction (or at least one or more of the micro-ops of the received instruction, e.g. the first one of the micro-ops) from executing whilst the hazard indication is set.

When the in-flight instruction executes and writes its result to the register(s), the VPU 101 clears (i.e. removes) the hazard indication for the executing instruction from the entry of the control storage 102. Recall that the hazarding information indicates which other instructions each instruction is hazarding against. The hazard indication may be cleared by the in-flight instruction, e.g. the micro-op of the in-flight instruction that causes the writing of the result to the register(s). The executing instruction clears the hazard indication (e.g. the flag) for that instruction from all the entries in the control storage 102 that are associated with instructions that are younger (i.e. are received after) than the executing instruction. This is a cheap operation.

The control storage 102 may track which registers are to be read by the received instruction (or the micro-op(s) of an instruction). Each micro-op may be configured to read from (e.g. consume) a sub-set of the registers that are to be read by the instruction as a whole. Here, “sub-set” may mean one, some or all of the registers. Similarly, the control storage 102 may track which registers are to be written to by an instruction (or the micro-op(s) of an instruction). This information may be used to facilitate hazarding.

The processing of the received instruction may then be dependent on the registers to which the earlier in-flight instructions write to, and the registers from which the received instruction reads from.

The VPU 101 may start executing the received instruction such that the instruction (e.g. one or more micro-ops) of the received instruction reads from one or more registers that have just been written to by the executing instruction, i.e. the instruction that just caused the hazard indication to be cleared. In some examples, before the received instruction (e.g. one or more micro-ops of the received instruction) starts executing, the instruction may first check that there are no other in-flight instructions that are in the process of writing to the register(s) from which the instruction (e.g. the one or more micro-ops) will first read. Only if there are no hazards will the instruction begin reading from the register(s).

In some examples, the instruction may require data from multiple different registers (or multiple different sets of registers, e.g. data may be taken from multiple registers by a given micro-op). For each different set of registers, the VPU 101 may be configured to, when (or after) reading from a first set of registers, determine if there are any hazards for the next set of registers. That is, the VPU 101 may check if there are any in-flight instructions that will write to the next required register(s), before attempting to read from the next register. As above, the checking may be performed by the received instruction (e.g. the individual micro-ops of the instruction).

If there are any in-flight instructions that will write to the next set of registers, a hazard indication (e.g. flag) is set in the control storage 102. This prevents the instruction (e.g. the next micro-op of the instruction) from reading from the next set of registers. The hazard indication is then cleared when the in-flight instruction executes and produces a result for relevant register(s) of the next set of registers. This then allows the received instruction to continue executing by reading from the next set of registers, or forwarding the result that will be written to the next set of registers. This process repeats for each set of registers.

An instruction will go through a number of rounds of checking for hazards equal to the number of micro-ops that the instruction is split into (assuming each micro-op of the instruction reads from at least one register), or equivalently, the number of different sets of registers that will be read by the micro-ops of the instruction.

The following provides an illustrative example. A first instruction is in-flight and has two micro-ops: a first micro-op that will produce to register v0 and a second micro-op that will produce to v1. A second instruction is received by the VPU 101 and is split into two micro-ops: a first micro-op that will consume registers v0 and v4 and a second micro-op that will consume registers v1 and v5. The first micro-op of the second instruction cannot start executing until the first micro-op of the first instruction has produced a result for register v0. When the second instruction is received by the VPU 101, the 2nd instruction looks for in-flight instructions that produce to any registers that it consumes, including v0 and v1, and sets a hazard flag that points to the first instruction. The hazard flag is set in the control storage 102. When the first micro-op of the first instruction executes, it clears the hazard flag for the second instruction. The first micro-op of the second instruction can then start executing. The second micro-op of the second instruction cannot execute and instead must wait until the second micro-op of the first instruction executes (since it produces to a register that is to be consumed from). When the first micro-op of the second instruction starts executing, it checks if the source registers of the second micro-op (i.e. v1 and v5) hazard against any in-flight instructions, and sets a hazard flag. When the second micro-op of the first instruction produces to v1, it clears the hazard flag for the second instruction. The second instruction can then execute.

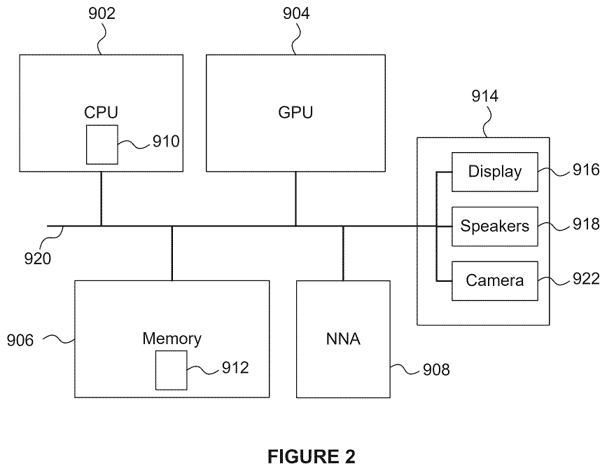

FIG. 2 shows a computer system in which processing systems described herein may be implemented. The computer system comprises a CPU 902, a GPU 904, a memory 906, a neural network accelerator (NNA) 908 and other devices 914, such as a display 916, speakers 918 and a camera 922. A processing block 910 (corresponding to processing blocks 101) is implemented on the CPU 902. In other examples, one or more of the depicted components may be omitted from the system, and/or the processing block 910 may be implemented on the GPU 904 or within the NNA 908. The components of the computer system can communicate with each other via a communications bus 920. A store 912 is implemented as part of the memory 906.

The processing system of FIGS. 1 and 2 are shown as comprising a number of functional blocks. This is schematic only and is not intended to define a strict division between different logic elements of such entities. Each functional block may be provided in any suitable manner. It is to be understood that intermediate values described herein as being formed by a processing system need not be physically generated by the processing system at any point and may merely represent logical values which conveniently describe the processing performed by the processing system between its input and output.

The processing system described herein may be embodied in hardware on an integrated circuit. The processing system described herein may be configured to perform any of the methods described herein. Generally, any of the functions, methods, techniques or components described above can be implemented in software, firmware, hardware (e.g., fixed logic circuitry), or any combination thereof. The terms “module,” “functionality,” “component”, “element”, “unit”, “block” and “logic” may be used herein to generally represent software, firmware, hardware, or any combination thereof. In the case of a software implementation, the module, functionality, component, element, unit, block or logic represents program code that performs the specified tasks when executed on a processor. The algorithms and methods described herein could be performed by one or more processors executing code that causes the processor(s) to perform the algorithms/methods. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The terms computer program code and computer readable instructions as used herein refer to any kind of executable code for processors, including code expressed in a machine language, an interpreted language or a scripting language. Executable code includes binary code, machine code, bytecode, code defining an integrated circuit (such as a hardware description language or netlist), and code expressed in a programming language code such as C, Java or OpenCL. Executable code may be, for example, any kind of software, firmware, script, module or library which, when suitably executed, processed, interpreted, compiled, executed at a virtual machine or other software environment, cause a processor of the computer system at which the executable code is supported to perform the tasks specified by the code.

A processor, computer, or computer system may be any kind of device, machine or dedicated circuit, or collection or portion thereof, with processing capability such that it can execute instructions. A processor may be or comprise any kind of general purpose or dedicated processor, such as a CPU, GPU, NNA, System-on-chip, state machine, media processor, an application-specific integrated circuit (ASIC), a programmable logic array, a field-programmable gate array (FPGA), or the like. A computer or computer system may comprise one or more processors.

It is also intended to encompass software which defines a configuration of hardware as described herein, such as HDL (hardware description language) software, as is used for designing integrated circuits, or for configuring programmable chips, to carry out desired functions. That is, there may be provided a computer readable storage medium having encoded thereon computer readable program code in the form of an integrated circuit definition dataset that when processed (i.e. run) in an integrated circuit manufacturing system configures the system to manufacture a processing system configured to perform any of the methods described herein, or to manufacture a processing system comprising any apparatus described herein. An integrated circuit definition dataset may be, for example, an integrated circuit description.

Therefore, there may be provided a method of manufacturing, at an integrated circuit manufacturing system, a processing system as described herein. Furthermore, there may be provided an integrated circuit definition dataset that, when processed in an integrated circuit manufacturing system, causes the method of manufacturing a processing system to be performed.

An integrated circuit definition dataset may be in the form of computer code, for example as a netlist, code for configuring a programmable chip, as a hardware description language defining hardware suitable for manufacture in an integrated circuit at any level, including as register transfer level (RTL) code, as high-level circuit representations such as Verilog or VHDL, and as low-level circuit representations such as OASIS (RTM) and GDSII. Higher level representations which logically define hardware suitable for manufacture in an integrated circuit (such as RTL) may be processed at a computer system configured for generating a manufacturing definition of an integrated circuit in the context of a software environment comprising definitions of circuit elements and rules for combining those elements in order to generate the manufacturing definition of an integrated circuit so defined by the representation. As is typically the case with software executing at a computer system so as to define a machine, one or more intermediate user steps (e.g. providing commands, variables etc.) may be required in order for a computer system configured for generating a manufacturing definition of an integrated circuit to execute code defining an integrated circuit so as to generate the manufacturing definition of that integrated circuit.

An example of processing an integrated circuit definition dataset at an integrated circuit manufacturing system so as to configure the system to manufacture a processing system will now be described with respect to FIG. 3.

FIG. 3 shows an example of an integrated circuit (IC) manufacturing system 1002 which is configured to manufacture a processing system as described in any of the examples herein. In particular, the IC manufacturing system 1002 comprises a layout processing system 1004 and an integrated circuit generation system 1006. The IC manufacturing system 1002 is configured to receive an IC definition dataset (e.g. defining a processing system as described in any of the examples herein), process the IC definition dataset, and generate an IC according to the IC definition dataset (e.g. which embodies a processing system as described in any of the examples herein). The processing of the IC definition dataset configures the IC manufacturing system 1002 to manufacture an integrated circuit embodying a processing system as described in any of the examples herein.

The layout processing system 1004 is configured to receive and process the IC definition dataset to determine a circuit layout. Methods of determining a circuit layout from an IC definition dataset are known in the art, and for example may involve synthesising RTL code to determine a gate level representation of a circuit to be generated, e.g. in terms of logical components (e.g.

NAND, NOR, AND, OR, MUX and FLIP-FLOP components). A circuit layout can be determined from the gate level representation of the circuit by determining positional information for the logical components. This may be done automatically or with user involvement in order to optimise the circuit layout. When the layout processing system 1004 has determined the circuit layout it may output a circuit layout definition to the IC generation system 1006. A circuit layout definition may be, for example, a circuit layout description.

The IC generation system 1006 generates an IC according to the circuit layout definition, as is known in the art. For example, the IC generation system 1006 may implement a semiconductor device fabrication process to generate the IC, which may involve a multiple-step sequence of photo lithographic and chemical processing steps during which electronic circuits are gradually created on a wafer made of semiconducting material. The circuit layout definition may be in the form of a mask which can be used in a lithographic process for generating an IC according to the circuit definition. Alternatively, the circuit layout definition provided to the IC generation system 1006 may be in the form of computer-readable code which the IC generation system 1006 can use to form a suitable mask for use in generating an IC.

The different processes performed by the IC manufacturing system 1002 may be implemented all in one location, e.g. by one party. Alternatively, the IC manufacturing system 1002 may be a distributed system such that some of the processes may be performed at different locations, and may be performed by different parties. For example, some of the stages of: (i) synthesising RTL code representing the IC definition dataset to form a gate level representation of a circuit to be generated, (ii) generating a circuit layout based on the gate level representation, (iii) forming a mask in accordance with the circuit layout, and (iv) fabricating an integrated circuit using the mask, may be performed in different locations and/or by different parties.

In other examples, processing of the integrated circuit definition dataset at an integrated circuit manufacturing system may configure the system to manufacture a processing system without the IC definition dataset being processed so as to determine a circuit layout. For instance, an integrated circuit definition dataset may define the configuration of a reconfigurable processor, such as an FPGA, and the processing of that dataset may configure an IC manufacturing system to generate a reconfigurable processor having that defined configuration (e.g. by loading configuration data to the FPGA).

In some embodiments, an integrated circuit manufacturing definition dataset, when processed in an integrated circuit manufacturing system, may cause an integrated circuit manufacturing system to generate a device as described herein. For example, the configuration of an integrated circuit manufacturing system in the manner described above with respect to FIG. 3 by an integrated circuit manufacturing definition dataset may cause a device as described herein to be manufactured.

In some examples, an integrated circuit definition dataset could include software which runs on hardware defined at the dataset or in combination with hardware defined at the dataset. In the example shown in FIG. 3, the IC generation system may further be configured by an integrated circuit definition dataset to, on manufacturing an integrated circuit, load firmware onto that integrated circuit in accordance with program code defined at the integrated circuit definition dataset or otherwise provide program code with the integrated circuit for use with the integrated circuit.

The implementation of concepts set forth in this application in devices, apparatus, modules, and/or systems (as well as in methods implemented herein) may give rise to performance improvements when compared with known implementations. The performance improvements may include one or more of increased computational performance, reduced latency, increased throughput, and/or reduced power consumption. During manufacture of such devices, apparatus, modules, and systems (e.g. in integrated circuits) performance improvements can be traded-off against the physical implementation, thereby improving the method of manufacture. For example, a performance improvement may be traded against layout area, thereby matching the performance of a known implementation but using less silicon. This may be done, for example, by reusing functional blocks in a serialised fashion or sharing functional blocks between elements of the devices, apparatus, modules and/or systems. Conversely, concepts set forth in this application that give rise to improvements in the physical implementation of the devices, apparatus, modules, and systems (such as reduced silicon area) may be traded for improved performance. This may be done, for example, by manufacturing multiple instances of a module within a predefined area budget.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

What is claimed is:

1. A computer-implemented method of processing instructions by a vector processing unit, wherein the vector processing unit comprises control storage, wherein the control storage comprises a plurality of entries, and wherein each entry is configured to store state and/or logic associated with a respective instruction, the method comprising:
receiving a current instruction, wherein the current instruction is configured to consume from a set of target registers;
determining that there is at least one respective earlier instruction that is configured to produce to one or more of the target registers; and
setting, in a respective entry of the control storage, a hazard indication indicating that there is respective earlier instruction configured to produce to one or more of the target registers, wherein the current instruction is prevented from consuming from the set of target registers whilst the respective entry comprises the hazard indication.

2. The method of claim 1, further comprising:
removing the hazard indication from the respective entry of the control storage when the respective earlier instruction produces to said one or more of the target registers; and
processing the current instruction, wherein processing the current instruction comprises consuming from at least a first one of the target registers.

3. The method of claim 2, wherein said processing further comprises:
before consuming from at least the first one of the target registers, determining there are no respective earlier instructions configured to produce to at least the first one of the target registers, and only then consuming from at least the first one of the target registers.

4. The method of claim 2, wherein said processing further comprises:
determining that there is at least one respective earlier instruction that is configured to produce to one or more of the target registers; and
setting, in the respective entry of the control storage, a hazard indication indicating the at least one respective earlier instruction is configured to produce to one or more of the target registers, wherein the current instruction is prevented from consuming from the set of target registers whilst the respective entry comprises the hazard indication.

5. The method of claim 4, further comprising:
removing the hazard indication from the respective entry of the control storage when the respective earlier instruction produces to said one or more of the target registers; and
processing the current instruction, wherein processing the current instruction comprises consuming from at least a second one of the target registers.

6. The method of claim 1, wherein the current instruction is configured to determine that there is at least one respective earlier instruction that is configured to produce to the one or more of the target registers.

7. The method of claim 1, wherein the current instruction is configured to set the hazard indication in the respective entry of the control storage.

8. The method of claim 1, wherein the respective earlier instruction is configured to remove the hazard indication from the respective entry of the control storage.

9. The method of claim 7, wherein:
the current instruction comprises a series of respective consume micro-ops, each respective consume micro-op configured to consume from a respective sub-set of the target registers;
a respective first produce micro-op of a respective earlier instruction is configured to produce to a respective sub-set of the target registers of a first respective consume micro-op;
a respective second produce micro-op of a respective earlier instruction is configured to produce to a respective sub-set of the target registers of a second respective consume micro-op; and
wherein the method further comprises:
the respective first produce micro-op removing the hazard indication from the respective entry of the control storage upon producing to the respective sub-set of target registers of the first respective consume micro-op;
the respective first consume micro-op setting, in the respective entry of the control storage, the hazard indication indicating that there is a respective earlier instruction configured to produce to one or more of the target registers; and
the respective second produce micro-op removing the hazard indication from the respective entry of the control storage upon producing to the respective sub-set of target registers of the second respective consume micro-op.

10. The method of claim 1, further comprising:
for each respective earlier instruction, storing, in a respective entry of the control storage, a respective indication of each respective register that the respective earlier instruction will produce to; and wherein said determining that there is at least one respective earlier instruction that is configured to produce to one or more of the target registers is based on the respective indications stored in the respective entries of the control cache.

11. A processing system configured to perform a method of processing instructions by a vector processing unit, wherein the vector processing unit comprises control storage, wherein the control storage comprises a plurality of entries, and wherein each entry is configured to store state and/or logic associated with a respective instruction, wherein the method comprises:
receiving a current instruction, wherein the current instruction is configured to consume from a set of target registers;
determining that there is at least one respective earlier instruction that is configured to produce to one or more of the target registers; and
setting, in a respective entry of the control storage, a hazard indication indicating that there is respective earlier instruction configured to produce to one or more of the target registers, wherein the current instruction is prevented from consuming from the set of target registers whilst the respective entry comprises the hazard indication.

12. A vector processing unit comprising:
a plurality of registers configured to store data; and
control storage comprising a plurality of entries, wherein each entry is configured to store state and/or logic associated with a respective instruction;
wherein the vector processing unit is configured to:
receive a current instruction, wherein the current instruction is configured to consume from a set of target registers of the plurality of registers;
determine that there is at least one respective earlier instruction that is configured to produce to one or more of the target registers;
set, in a respective entry of the control storage, hazarding information indicating the at least one respective earlier instruction is configured to produce to one or more of the target registers; and
prevent the current instruction from consuming from the set of target registers whilst the respective entry comprises the hazard indication.

13. The vector processing unit of claim 12, wherein the vector processing unit is further configured to:
remove the hazard indication from the respective entry of the control storage when the respective earlier instruction produces to said one or more of the target registers; and
process the current instruction, wherein processing the current instruction comprises consuming from at least a first one of the target registers.

14. The vector processing unit of claim 13, wherein the vector processing unit is further configured to:
determine there are no respective earlier instructions configured to produce to at least the first one of the target registers; and
only consume from at least the first one of the target registers when there are no respective earlier instructions configured to produce to at least the first one of the target registers.

15. The vector processing unit of claim 13, wherein the vector processing unit is further configured to:
determine that there is at least one respective earlier instruction that is configured to produce to one or more of the target registers;
set, in the respective entry of the control storage, hazarding information indicating the at least one respective earlier instruction is configured to produce to one or more of the target registers; and
prevent the current instruction from consuming from the set of target registers whilst the respective entry comprises the hazard indication.

16. The vector processing unit of claim 12, wherein the current instruction is configured to determine that there the at least one respective earlier instruction that is configured to produce to the one or more of the target registers, and wherein the vector processing unit is configured to process the current instruction to determine that there is at least one respective earlier instruction that is configured to produce to one or more of the target registers.

17. The vector processing unit of claim 12, wherein the current instruction is configured to set the hazard indication in the respective entry of the control storage, and wherein the vector processing unit is configured to process the current instruction to set the hazard indication in the respective entry of the control storage.

18. The vector processing unit of claim 12, wherein the respective earlier instruction is configured to remove the hazard indication from the respective entry of the control storage, and wherein the vector processing unit is configured to process the respective earlier instruction to remove the hazard indication from the respective entry of the control storage.

19. The vector processing unit of claim 17, wherein:
the current instruction comprises a series of respective consume micro-ops, each respective consume micro-op being configured to consume from a respective sub-set of the target registers;
a respective first produce micro-op of a respective earlier instruction is configured to produce to a respective sub-set of the target registers of a first respective consume micro-op; and
a respective second produce micro-op of a respective earlier instruction is configured to produce to a respective sub-set of the target registers of a second respective consume micro-op; and
wherein the vector processing unit is further configured to:
process the respective first produce micro-op to i) produce to the respective sub-set of target registers of the respective first consume micro-op, and ii) remove the hazard indication from the respective entry of the control storage;
process the respective first consume micro-op to set, in the respective entry of the control storage, the hazard indication indicating that there is a respective earlier instruction configured to produce to one or more of the target registers; and
process the respective second produce micro-op to i) produce to the respective sub-set of target registers of the second respective consume micro-op, and ii) remove the hazard indication from the respective entry of the control storage.

20. The vector processing unit of claim 12, wherein the vector processing unit is further configured to:
for each respective earlier instruction, store, in a respective entry of the control storage, a respective indication of each respective register that the respective earlier instruction will produce to; and
use the respective indications stored in the respective entries of the control storage to determine that there is the at least one respective earlier instruction that is configured to produce to one or more of the target registers.
